(19) United States
(12) Patent Application Publication
(10) Pub. No.: US 2007/0111593 A1
(43) Pub. Date: May 17, 2007

(54) Terminal box

(76) Inventor: Guen Soo Kim, Gwangmyeong City (KR)

Correspondence Address: IPLA P.A., 3580 WILSHIRE BLVD., 17TH FLOOR, LOS ANGELES, CA, 90010, US

(21) Appl. No.: 10/571,848

(22) PCT Filed: Sep. 16, 2004
(86) PCT No.: PCT/KR04/02363

§ 371 Date: Mar. 15, 2006

(30) Foreign Application Priority Data
Sep. 16, 2003 (KR) 10-2003-0063963
May 3, 2004 (KR) 20-2004-0012359

(51) Int. Cl. H01R 13/66

(52) U.S. Cl. 439/536

(57) ABSTRACT

A terminal box is disclosed. The terminal box includes a terminal box body embedded in a wall and for providing a space for installation of a terminal and a switch to connect an incoming electric wire, telephone line, designated Internet line, antenna line, or the like, and a cover coupled to the front of the terminal box body. The cover is provided at the center thereof with an installation aperture for the switch, the plug, and like, and at both sides a resting face for installing a connection panel. In addition, the cover and the connection panel can be integrally connected with each other by installing a support rod across the rear surface thereof, so that deformation such as sagging can be prevented when in use. The terminal box is constructed so as to be able to improve the installation efficiency and reduce the manufacturing cost.

### TECHNICAL FIELD

The present invention relates to a terminal box for providing a space for installation of a terminal to connect a electric wire, a telephone line, a designated Internet line, an antenna line or the like. More particularly, the invention relates to such a terminal box, in which the cover of a terminal box body can be used for connecting a plurality of terminal box bodies continuously by coupling a connection panel at both sides thereof, together with the existing working aperture.

### BACKGROUND ART

In general, a terminal box is embedded in a wall structure, when a detached house, a town house, or a lager building is built, and used for providing a space for installation of a terminal or a switch to connect the incoming electric wire, telephone line, designated Internet line, antenna line, and the like.

In order to install these terminal boxes in the wall, a prepared terminal box is placed in the wall structure with its opening directed inwards, and a cover is disposed thereabove, and then a cement mortar is placed, so that the terminal box can be embedded in the wall to thereby form a fixed structure.

However, plural terminal boxes can be embedded in the wall structure in the same manner as described above, but in this case a gap between neighboring terminal boxes can be necessarily maintained. If the gap is not properly maintained, the terminal box is tilted during the concrete placing work, thereby resulting in a faulty installation of the terminal box, and thus occasionally a reinstallation, which might lead to destruction of the wall structure.

Therefore, in order to avoid these faulty installation, as shown in FIG. 1, a separate fixing panel 20 formed of a metal plate is provided at the front side of terminal boxes 10. The fixing panel is used for fixing plural terminal boxes 10 to thereby maintain a gap between the terminal boxes.

However, the convention terminal box employs the fixing panel 20 formed of a metal sheet, thereby increasing the manufacturing cost. That, a lid 12 is installed in the front side of the terminal box 10, and the fixing panel 20 formed of a metal plate is installed in the front side of the lid 12, so that the lid 12 and the fixing panel 20 are installed, in duplicate, in the front side of the terminal box 10, thereby leading to an increase in the cost thereof.

In addition, an installation error of the fixing panel to the terminal box results in a significant reduction in the work efficiency.

### DISCLOSURE OF INVENTION

The present invention has been made to solve the above problems in the art, and it is an object of the invention to provide a terminal box, in which, in the case where a plurality of terminal boxes are installed in a wall structure, a gap between neighboring terminal boxes can be maintained, thereby improving the installation efficiency and enabling the mass production thereof, which results in a cost reduction.

Another object of the invention is to provide a terminal box, which can prevent the cover thereof from deformation such as sagging, or the like.

In order to accomplish the above objects, according to one aspect of the present invention, there is provided a terminal box internally having an accommodating space for installing a terminal and a switch, which connects an incoming communication or electric wire therethrough. The terminal box is embedded in a concrete wall. The terminal box includes: a terminal box body of a rectangular shape opened forwardly to from an opened portion and having a pair of wire inlets formed at each of both sides thereof so as to communicate with the accommodating space; a plate-shaped cover coupled to the front end of the terminal box body to cover the opened portion of the terminal box body, the cover being formed at the center portion thereof with an installation aperture for communicating with the accommodating space via the opened portion of the terminal box body, and being respectively formed at both sides thereof with an inwardly stepped-down resting face having with a certain width, the resting face having at least one coupling hole formed thereon; and a connection panel for connecting continuously neighboring covers in series such that it is installed on the resting face of the cover and forms the same plane with the cover, the width of the connection panel being twice as much as that of each resting face, the connection panel having at least one coupling projection formed on the rear surface thereof to be detachably coupled to the least one coupling hole formed on the resting face of the cover, the connection panel having the shape of a plate and being formed of the same material as the cover.

Preferably, the cover and the connection panel may further include, at the upper and lower portions thereof, a bent portion bent towards the terminal box body, respectively.

The coupling projection is in the form of a hook.

According to another aspect of the invention, there is provided a terminal box having an accommodating space for installing a terminal and a switch, which connects an incoming communication or electric wire. The terminal box is to be embedded in a concrete wall. The terminal box comprises: a terminal box body of a rectangular shape opened forwardly to form an opened portion and having a pair of wire inlets formed at each of both sides thereof so as to communicate with the accommodating space; a plate-shaped cover coupled to the front end of the terminal box body to cover the opened portion of the terminal box body, the cover being formed at the center portion thereof with an installation aperture for communicating with the accommodating space via the opened portion of the terminal box body, and being respectively formed at both sides thereof with an inwardly stepped-down resting face having with a certain width, the resting face having at least one coupling hole; and a connection panel for connecting continuously neighboring covers in series such that it is installed on the resting face of the cover and forms the same plane with the cover, the width of the connection panel being twice as much as that of each resting face, the connection panel having at least one coupling projection formed on the rear surface thereof to be detachably coupled to the least one coupling hole formed on the resting face of the cover, the connection panel having the shape of a plate and being formed of the same material as the cover; and a support rod inserted into insert holes provided in projections, which are formed respectively in the rear surfaces of the connection panel and the cover so that the cover and the connection panel are integrally connected with each other by means of the support rod horizontally crossing the cover and the connection panel.

Preferably, the support rod is installed such that it is placed at the upper and lower portions of the rear surface of the cover and the connection panel.

### BRIEF DESCRIPTION OF DRAWINGS

Further objects and advantages of the invention can be more fully understood from the following detailed description taken in conjunction with the accompanying drawings, in which:

FIG. 1 shows a conventional terminal box having a fixing panel for embedding it to a wall structure:

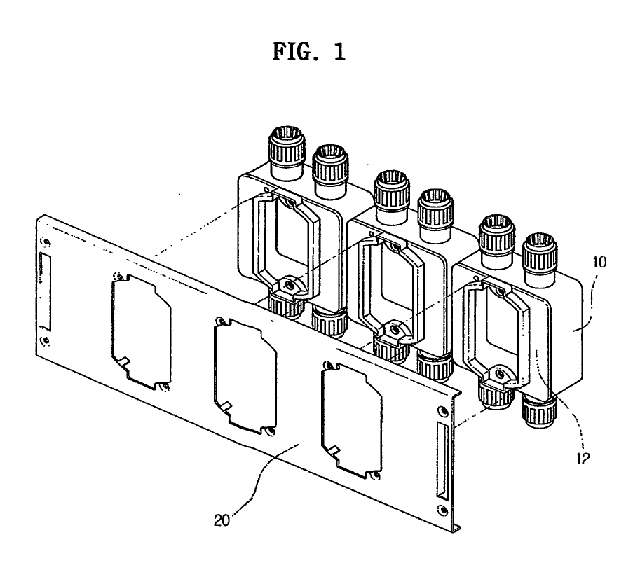

FIG. 2 is a perspective exploded view of the terminal box according to one embodiment;

FIG. 3 is a perspective view showing a continuous connection of the terminal box covers by means of a connection panel;

FIG. 4 is a perspective view showing a terminal box installed in the cover of FIG. 3;

FIG. 5 is a top plan view of FIG. 4;

FIG. 6 is a perspective exploded view of a terminal box according to a second embodiment of the invention;

FIG. 7 is a perspective exploded view of the terminal box of FIG. 6, which is seen from the rear side thereof;

FIG. 8 is a perspective view of the covers continuously connected in the terminal box of FIG. 6;

FIG. 9 is a rear view of FIG. 8;

FIG. 10 is a cross-sectional view taken along the line I-I line in FIG. 9;

FIG. 11 is a cross-sectional view taken along the line II-II in FIG. 10;

FIG. 12 is a cross-sectional view taken along the line C-C in FIG. 12;

FIG. 13 is a perspective view showing a modified embodiment, which has a plurality of covers and a plurality of connection panels correspondingly thereto;

FIG. 14 is a perspective view of the rear view of FIG. 13, in which only the cover and connection panels are illustrated; and

FIG. 15 is a perspective view of FIG. 14, in which the covers are continuously connected by means of the connection panel.

### BEST MODE FOR CARRYING OUT THE INVENTION

The preferred embodiments of the invention will be explained in detail with reference to the accompanying drawings.

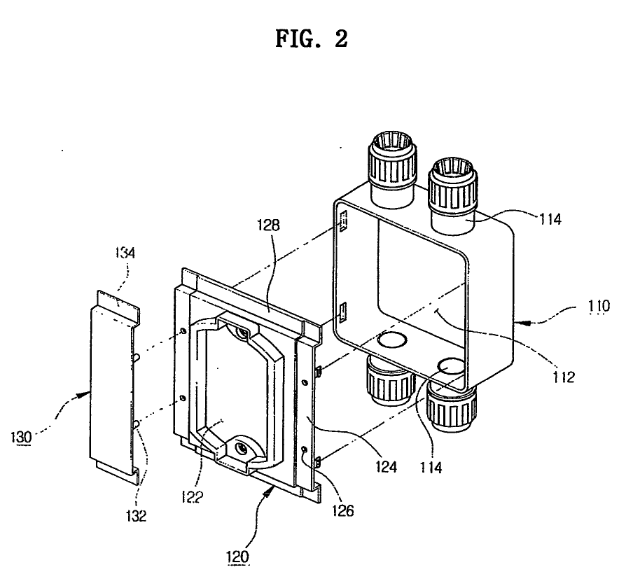

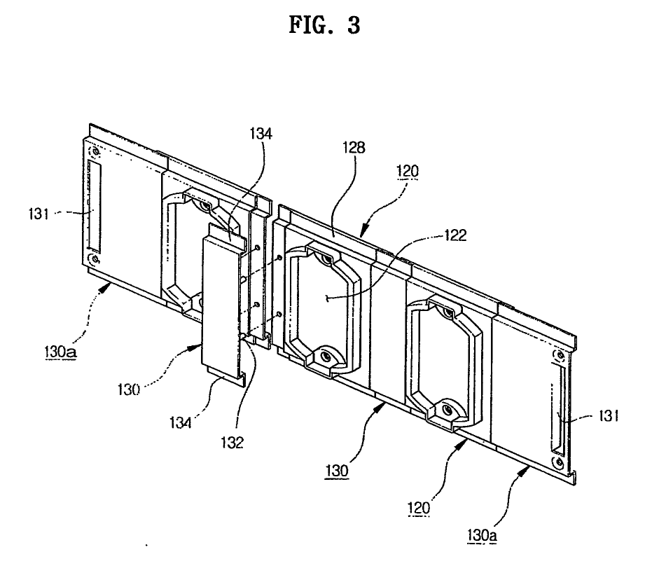

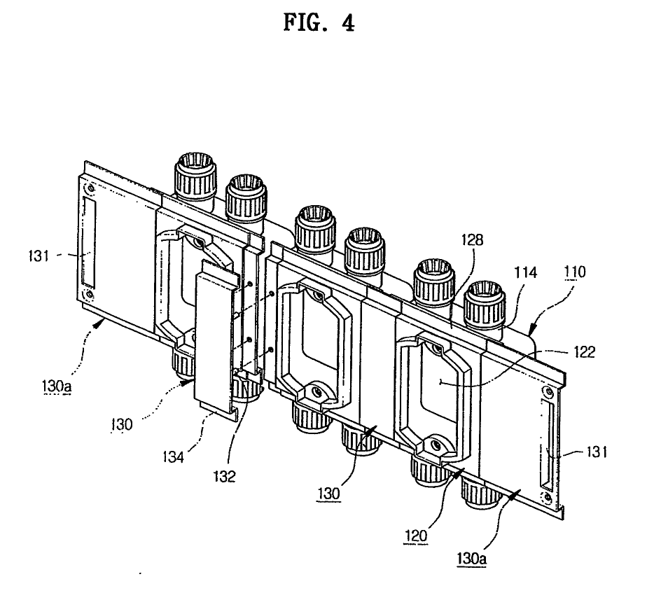

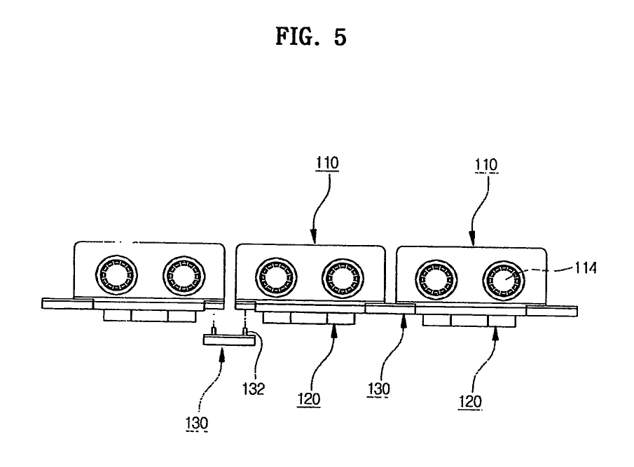

FIGS. 2 to 5 show a terminal box according to a first embodiment of the invention. More specifically, FIG. 2 is a perspective exploded view of the terminal box according to one embodiment, FIG. 3 is a perspective view showing a continuous connection of the terminal box covers by means of a connection panel, FIG. 4 is a perspective view showing a terminal box installed in the cover of FIG. 3, and FIG. 5 is a top plan view of FIG. 4.

As shown in the figures, the terminal box according to the first embodiment of the invention is embedded in a concrete wall in order to provide a space, in which a terminal for connecting an incoming electric wire or the like can be installed. The terminal box is provided with a terminal box body 110. The terminal box body 110 comprises a rectangular box, which is embedded in the wall, and has an accommodating space 112 for installing a terminal and a plurality of wire inlet holes 114 communicating to the accommodating space 112. The wire inlet hole 114 is initially closed, and after embedded in the wall, can be punched out to make the inlet hole 114. The wire inlet hole 114 is formed of a groove for the convenience of punching-out the hole.

The above-described terminal box body 110 is installed in a certain number thereof, usually two or three terminal boxes, depending on the place where it is installed.

In addition, the terminal box body 110 is opened to the front side thereof so as to communicate with the accommodating space 112, so that a cover 120 is attached to the front side of the terminal box body. The number of the covers 120 corresponds to that of the terminal box body 110 to be installed. The cover 120 is installed in the front side of the terminal box body 110 and has an installation aperture 122 for installing a closure (not shown). At both sides of the cover is provided a stepped-down resting face 124, on which about two coupling holes 126 are formed.

A closure to be installed in the installation aperture 112 is intended to prevent the concrete mortar from in-flowing to the accommodating space 112 of the terminal box body 110, for example, during a concrete placing work or a plastering work. The concrete placing work or plastering work is carried out with the accommodating space closed by means of the closure installed in the installation aperture, and the closure is removed after finishing the work.

Furthermore, at both sides of the cover 120 is installed a connection panel 130, preferably which is rested and installed in the resting face 124 of the cover 120 such that the front faces of the cover 120 and the connection panel 130 can be on the same plane.

The connection panel 130 is installed between neighboring covers 120 to maintain a gap therebetween and thus maintain a gap between the terminal box bodies 110 with the cover 120 connected thereto. Such a connection panel 130 has about two coupling projections 132 formed on the rear surface thereof in such a manner as to correspond to positions of the coupling holes 126. Therefore, the connection panel 130 is firmly fixed to the cover 120 by the coupling hole and the coupling projection fitted together.

In addition, the connection panel 130 and the cover 120 respectively have a bent portion 128, 134 formed in the upper and lower portions thereof. The bent portions 128, 134 facilitate a firm and easy connection with the terminal box bodies 110, and prevent a movement after connection thereof by supporting the upper and lower portions of the terminal box body 110 by means of the bent portions 128, 134.

The above connection panel 130 is placed at both sides of the cover 120 and simply connected in such a manner that the coupling hole 126 formed in the cover 120 is fitted into the coupling projection 132 formed in the connection panel 130, thereby maintaining a gap between the terminal box bodies 110 to be fixed to the cover 120.

Furthermore, the connection panel 130 and the cover 120 may be mass-produced in a standardized fashion by an injection molding process, thereby improving the manufacturing efficiency and reducing the manufacturing cost. The number of covers 120 and connection panels 130 can be determined, depending on the number of terminal box bodies 110 to be installed, thereby enabling various applications.

In addition, in case where the connection panel 130 and the cover 120 are assembled in plural to form a unitary assembly, it is preferable that the connection panel 130a to be placed at both ends thereof is provided with a support plate 130 formed by bending inwardly. When the unitary assembly of the connection panels 130 and the covers 120 is embedded, both side portions of the assembly can be supported by the support plate 131.

According to the invention as described above, the terminal box is embedded beforehand when constructing a building. That is, after the terminal box body 110 with the cover 120 and the connection panel 130 assembled to the front face thereof is fixed to a supporting bar or the like forming a building frame structure, a concrete placing work is carried out. Therefore, the terminal box of the invention can be installed in a desired place of the wall while maintaining a certain gap between neighboring terminal box bodies.

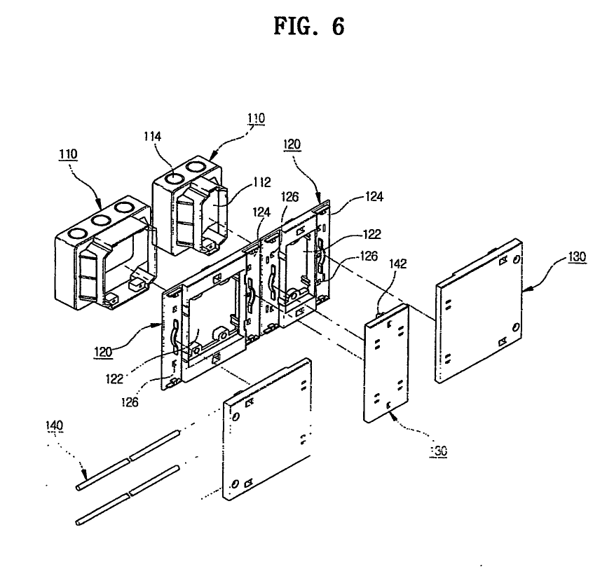

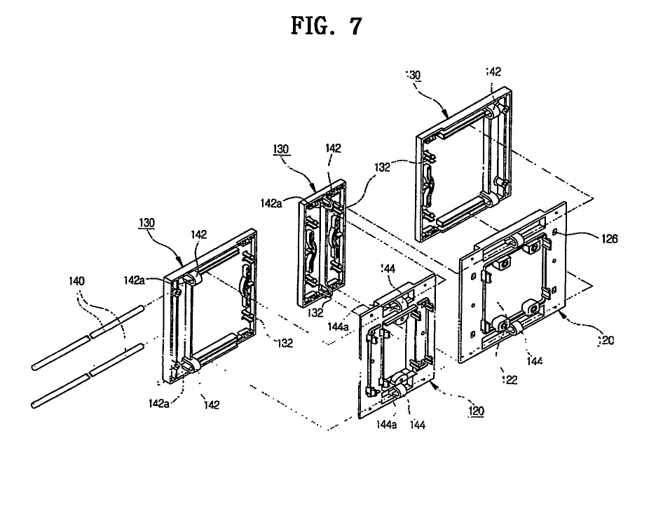

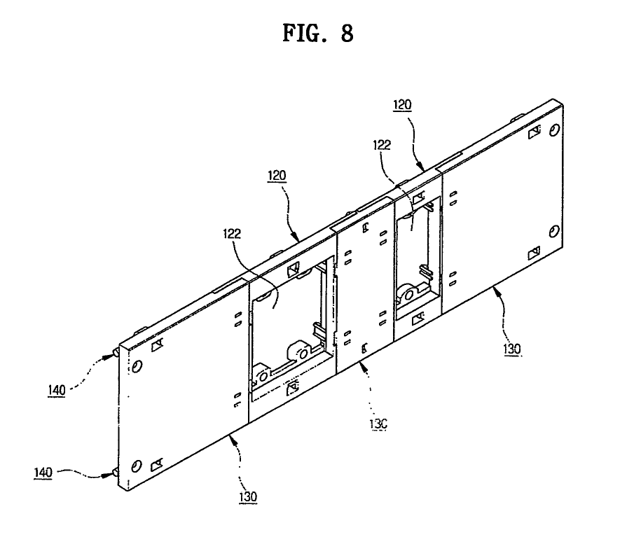

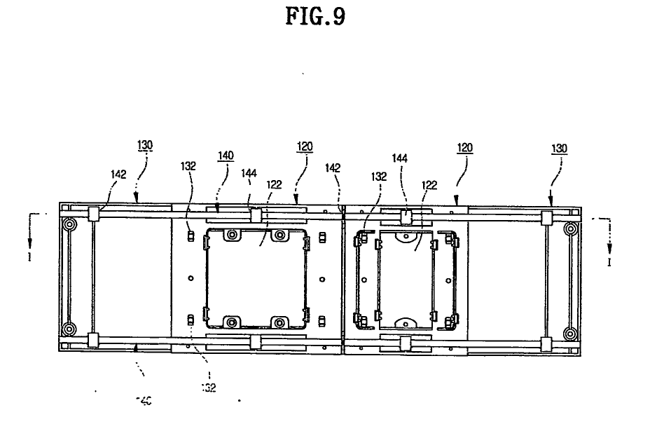

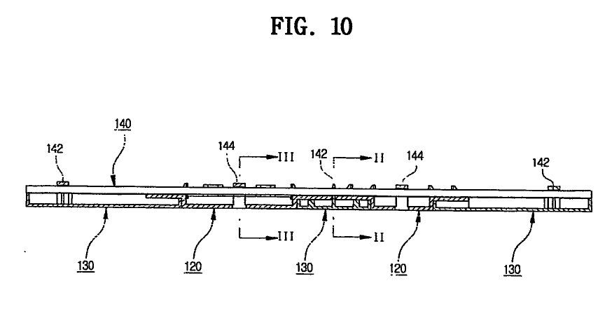

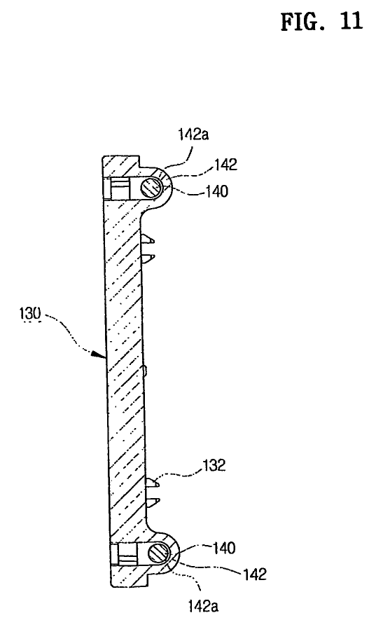

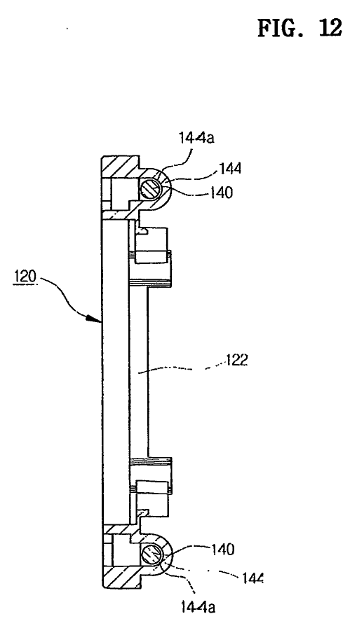

FIGS. 6 to 15 show a terminal box according to a second embodiment of the invention. More specifically, FIG. 6 is a perspective exploded view of a terminal box according to the second embodiment of the invention, FIG. 7 is a perspective exploded view of the terminal box of FIG. 6, which is seen from the rear side thereof, FIG. 8 is a perspective view of the covers continuously connected in the terminal box of FIG. 6, FIG. 9 is a rear view of FIG. 8, FIG. 10 is a cross-sectional view taken along the line I-I line in FIG. 9, FIG. 11 is a cross-sectional view taken along the line II-II in FIG. 10, and FIG. 12 is a cross-sectional view taken along the line C-C in FIG. 12.

As shown in the figures, the second embodiment of the invention has a similar construction to the previous first embodiment, and a similar element is denoted by a same reference numeral.

According to the second embodiment of the invention, the terminal box body 110 has the same construction as the first embodiment, except for its shape. In addition, similarly, the cover 120 and the connection panel 130 also is installed at the front face of the terminal box body 110 to maintain a gap between neighboring ones, which are different from the first embodiment in terms of their shape and pattern.

Furthermore, the coupling projection 132 formed in the connection panel 130 is preferred to be formed in the shape of a hook. Therefore, the cover 120 cannot be easily released after the coupling hole 126 is inserted and coupled into the coupling projection 132.

As described above, according to the second embodiment of the invention, the connection panel 130 is provided at its rear surface with a first projection 142 projected rearwards through between the neighboring covers 120, and the cover 120 is provided with a second projection 144 formed at the rear surface thereof with the same height as the first projection 142. These first and second projections 142, 144 is internally provided with a first and second insert holes 141a, 144a in order for a support rod 140 to be inserted thereinto in a horizontal direction.

The support rod 140 is inserted horizontally into the first and second insert holes 142a, 144a so that the cover 120 and the connection panel 130 is prevented from sagging when assembled and connected with each other.

The insert holes 142a, 144a and the above support rod 140 inserted thereinto are preferred to be located at the upper and lower portions of the rear surface of the cover 120 and the connection panel 130, thereby more surely preventing the sagging of the cover 120 and connection panel 130.

Therefore, since the cover 120 and the connection panel 130 are firmly supported by the support rod 140, during a concrete placing work the concrete mortar can prevent the cover 120, the connection panel 130, and the terminal box fixed to the cover 120 from sagging, so that the terminal box can be installed in the correct position, thereby avoiding a faulty installation of terminal box.

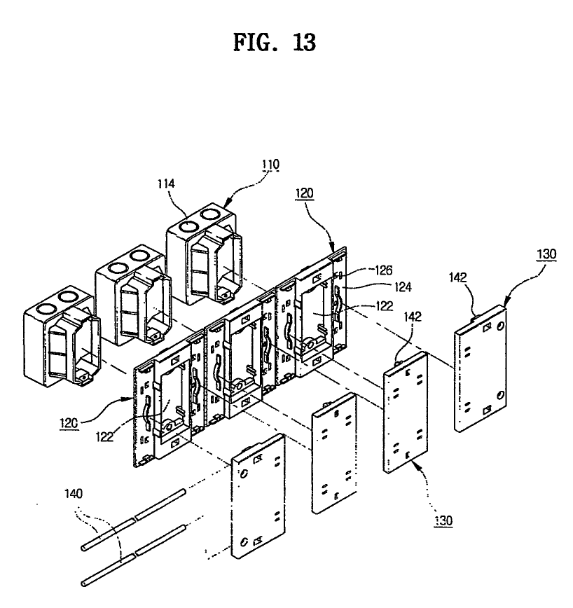

The second embodiment as described above illustrates two terminal box bodies 110, and FIGS. 13 to 15 show three terminal box bodies 110, but more than three terminal box bodies may be installed.

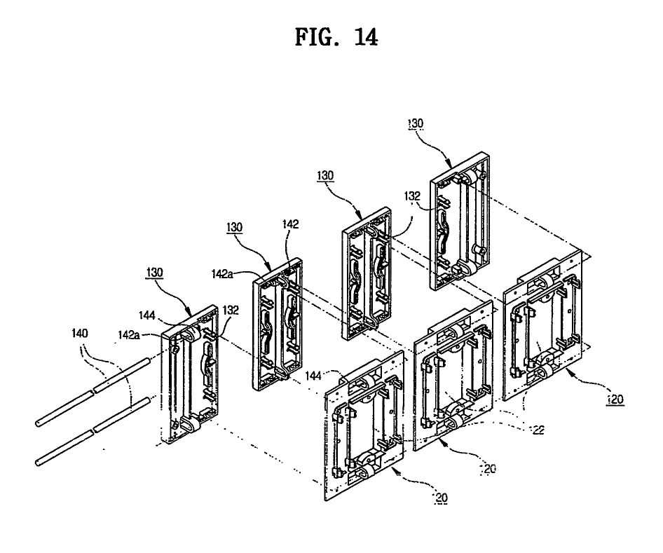

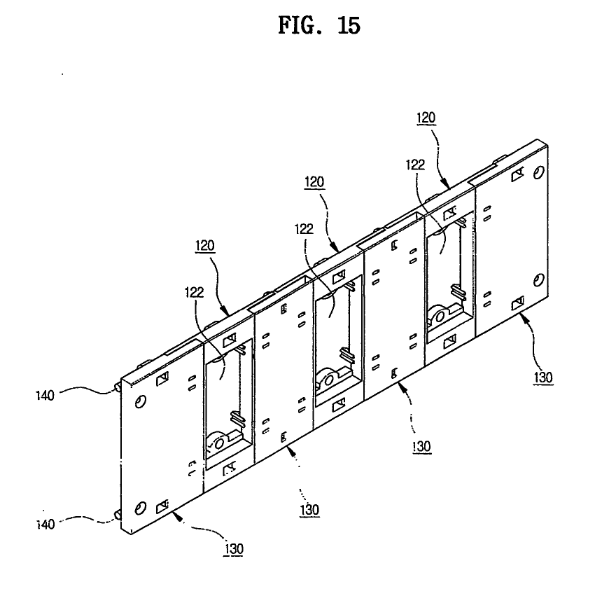

FIG. 13 is a perspective view showing a modified embodiment, which has a plurality of covers and a plurality of connection panels correspondingly thereto. FIG. 14 is a perspective view of the rear view of FIG. 13, in which only the cover and connection panels are illustrated, and FIG. 15 is a perspective view of FIG. 14, in which the covers are continuously connected by means of the connection panel.

The present invention shown in FIGS. 13 to 15 is different from the second embodiment, in terms of the number of the terminal box bodies 110 embedded in a wall, and the number of the covers 120 and the connection panels 130 installed forwards of the terminal box body 110.

In this way, the number of the cover 120 and the connection panel 130 is determined, depending on a desired number of the terminal box bodies 110 to be embedded in a wall. Usually, two or three terminal boxes are used most.

According to the second embodiment of the invention having the above-described construction, the terminal box bodies 110 is embedded beforehand when constructing a building. That is, after the terminal box body 110 with the cover 120 and the connection panel 130 assembled to the front face thereof is fixed to a supporting bar or the like forming a building frame structure, a concrete placing work is carried out. Therefore, the terminal box of the invention can be installed in a desired place of the wall while maintaining a certain gap between neighboring terminal box bodies.

At this time, the terminal box is firmly supported by the cover 120 fixed to the front of the terminal box body 100, the connection panel 130 connected between the covers 120, and the support rod 140. Therefore, the terminal box can sustain the pressure caused by the concrete mortar during the concrete placing work, so that the position of the terminal box is not displaced, thereby avoiding a faulty installation of terminal box.

### INDUSTRIAL APPLICABILITY

As understood from the above description, according to the present invention, a single cover can serve to maintain a gap between the terminal box bodies, along with the function as a cover for the terminal box body, thereby enabling an easy installation and thus improving working efficiency when embedding the terminal box in a wall. In addition, the reduction of components in the terminal box results in a cost-down effect. Furthermore, it can avoid deformation caused by its self-gravity due to a large number of covers when plural terminal boxes are arranged.

What is claimed is:

1. A terminal box internally having an accommodating space for installing a terminal and a switch, which connects an incoming communication or electric wire therethrough, the terminal box being embedded in a concrete wall, the terminal box comprising:
a) a terminal box body of a rectangular shape opened forwardly to form an opened portion and having a pair of wire inlets formed at each of both sides thereof so as to communicate with the accommodating space;
b) a plate-shaped cover coupled to the front end of the terminal box body to cover the opened portion of the terminal box body, the cover being formed at the center portion thereof with an installation aperture for communicating with the accommodating space via the opened portion of the terminal box body, and being respectively formed at both sides thereof with an inwardly stepped-down resting face having with a certain width, the resting face having at least one coupling hole formed thereon; and
c) a connection panel for connecting continuously neighboring covers in series such that it is installed on the resting face of the cover and forms the same plane with the cover, the width of the connection panel being twice as much as that of each resting face, the connection panel having at least one coupling projection formed on the rear surface thereof to be detachably coupled to the least one coupling hole formed on the resting face of the cover, the connection panel having the shape of a plate and being formed of the same material as the cover.

2. A terminal box according to claim 1, wherein the cover and the connection panel further include, at the upper and lower portions thereof, a bent portion bent towards the terminal box body, respectively.

3. A terminal box according to claim 1, wherein the coupling projection is in the form of a hook.

4. A terminal box internally having an accommodating space for installing a terminal and a switch, which connects an incoming communication or electric wire, the terminal box being to be embedded in a concrete wall, the terminal box comprising:
a) a terminal box body of a rectangular shape opened forwardly to form an opened portion and having a pair of wire inlets formed at each of both sides thereof so as to communicate with the accommodating space;
b) a plate-shaped cover coupled to the front end of the terminal box body to cover the opened portion of the terminal box body, the cover being formed at the center portion thereof with an installation aperture for communicating with the accommodating space via the opened portion of the terminal box body, and being respectively formed at both sides thereof with an inwardly stepped-down resting face having with a certain width, the resting face having at least one coupling hole formed thereon; and
c) a connection panel for connecting continuously neighboring covers in series such that it is installed on the resting face of the cover and forms the same plane with the cover, the width of the connection panel being twice as much as that of each resting face, the connection panel having at least one coupling projection formed on the rear surface thereof to be detachably coupled to the least one coupling hole formed on the resting face of the cover, the connection panel having the shape of a plate and being formed of the same material as the cover; and
d) a support rod inserted into insert holes provided in projections, which are formed respectively in the rear surfaces of the connection panel and the cover so that the cover and the connection panel are integrally connected with each other by means of the support rod horizontally crossing the cover and the connection panel.

5. A terminal box according to claim 4, wherein the support rod is installed such that it is placed at the upper and lower portions of the rear surface of the cover and the connection panel.
